(19) United States
(12) Patent Application Publication
(10) Pub. No.: US 2014/0222587 A1
(43) Pub. Date: Aug. 7, 2014

(54) BID ADJUSTMENT SUGGESTIONS BASED ON DEVICE TYPE

(71) Applicant: Google Inc., Mountain View, CA (US)

(72) Inventors: Jonathan Ezra Feldman, New York, NY (US); Daniel Magassy Percival, New York, NY (US); Lu Liu, Cupertino, CA (US); David Shanahan, Mountain View, CA (US); Alice S. Tull, Mountain View, CA (US); Surojit Chatterjee, Fremont, CA (US); Neil Inala, San Jose, CA (US); Jean Steiner, San Francisco, CA (US); Vinod Marur, Palo Alto, CA (US); Shibani Sanan, Saratoga, CA (US); William Martin Halpin, JR., Palo Alto, CA (US); Chrix Eric Finne, San Francisco, CA (US); Nicholas Johnson, Palo Alto, CA (US)

(73) Assignee: Google Inc., Mountain View, CA (US)

(21) Appl. No.: 14/049,889

(22) Filed: Oct. 9, 2013

Related U.S. Application Data
(63) Continuation of application No. 13/797,597, filed on Mar. 12, 2013.
(60) Provisional application No. 61/760,959, filed on Feb. 5, 2013.

(51) Int. Cl. G06Q 30/02

(52) U.S. Cl. CPC G06Q 30/0275
USPC 705/14.71

(57) ABSTRACT

Systems and methods for suggesting a bid adjustment value based on device type include receiving parameters for a third-party content provider's campaign to present third-party content on a first type of device. Based on the campaign's parameters, bids from peer providers that use similar campaign parameters for both the first type of device and another type of device may be identified. For example, bids from providers that use similar parameters as the campaign for both mobile and desktop devices may be identified. The identified bids from the peer providers may be used to calculate a bid adjustment value. The bid adjustment value can be provided for presentation to the third-party content provider as a suggested change to his or her bid for the first type of device, to establish a bid for the second type of device.

### CONTINUITY DATA

The present application claims priority to U.S. Provisional Application No. 61/760,959 entitled “BID ADJUSTMENT SUGGESTIONS BASED ON DEVICE TYPE,” and filed on Feb. 5, 2013, the entirety of which is hereby incorporated by reference. The present application also claims priority to U.S. patent application Ser. No. 13/797,597 entitled “BID ADJUSTMENT SUGGESTIONS BASED ON DEVICE TYPE,” and filed on Mar. 12, 2013, the entirety of which is hereby incorporated by reference.

Online content may be received from various first-party or third-party sources. In general, first-party content refers to the primary online content requested or displayed by the client device. For example, first-party content may be a webpage requested by the client or a stand-alone application (e.g., a video game, a chat program, etc.) running on the device. Third-party content, in contrast, refers to additional content that may be provided in conjunction with the first-party content. For example, third-party content may be a public service announcement or advertisement that appears in conjunction with a requested webpage (e.g., a search result webpage from a search engine, a webpage that includes an online article, a webpage of a social networking service, etc.) or within a stand-alone application (e.g., an advertisement within a game). More generally, a first-party content provider may be any content provider that allows another content provider (i.e., a third-party content provider) to provide content in conjunction with that of the first-party.

A third-party content provider, such as an advertiser, may create a campaign to control how and when their content is provided to a client device. For example, a third-party content provider may specify that they wish to only provide their content on a certain webpage or to devices located in a certain area. In some cases, third-party content providers may also compete against one another for the ability to provide their content. For example, an auction may be held that compares bid amounts specified as part of the providers' campaigns to determine which third-party content provider has the ability to place their content with that of the first-party provider. However, determining an appropriate bid amount to meet the third-party content providers' goals is often left to the individual providers to decide. Bidding too low may mean that a provider's content is never selected. Similarly, bidding too high may mean that a provider's budget is maxed out too quickly. It is challenging and difficult to develop a utility to suggest bid amounts to third-party content providers.

### SUMMARY

Implementations of the systems and methods for bid adjustment suggestions based on device type are disclosed herein. One implementation is a method of determining a bid adjustment value for a mixed platform campaign. The method includes receiving, at a processing circuit, parameters for a third-party content provider's campaign to present third-party content in conjunction with first-party content. The parameters include a bid amount for use in content auctions and one or more selection parameters configured to control when the bid amount is used in a content auction. The selection parameters specify at least a first type of client device associated with the bid amount to which the third-party content is to be provided. The method also includes identifying bid amounts from other third-party content providers' campaigns that use similar selection parameters as the third-party content provider's campaign, each third-party content provider having a campaign associated with the first type of client device and another campaign associated with a second type of client device. The method further includes determining an aggregate measure of the bid amounts from the other third-party content providers' campaigns associated with the first type of client device and determining an aggregate measure of the bid amounts from the other third-party content providers' campaigns associated with the second type of client device. The method additionally includes calculating a bid adjustment value that relates the aggregate measure of the bid amounts associated with the first type of client device to the aggregate measure of the bid amounts associated with the second type of client device. The method also includes providing the bid adjustment value for presentation to the third-party content provider to suggest a bid amount for the second type of client device.

Another implementation is a system for determining a bid adjustment value for a mixed platform campaign. The system includes a processing circuit configured to receive parameters for a third-party content provider's campaign to present third-party content in conjunction with first-party content. The parameters include a bid amount for use in content auctions and one or more selection parameters configured to control when the bid amount is used in a content auction. The selection parameters specify at least a first type of client device associated with the bid amount to which the third-party content is to be provided. The processing circuit is also configured to identify bid amounts from other third-party content providers' campaigns that use similar selection parameters as the third-party content provider's campaign, each third-party content provider having a campaign associated with the first type of client device and another campaign associated with a second type of client device. The processing circuit is further configured to determine an aggregate measure of the bid amounts from the other third-party content providers' campaigns associated with the first type of client device and to determine an aggregate measure of the bid amounts from the other third-party content providers' campaigns associated with the second type of client device. The processing circuit is additionally configured to calculate a bid adjustment value that relates the aggregate measure of the bid amounts associated with the first type of client device to the aggregate measure of the bid amounts associated with the second type of client device. The processing circuit is also configured to provide the bid adjustment value for presentation to the third-party content provider to suggest a bid amount for the second type of client device.

A further implementation is a computer-readable storage medium having machine instructions stored therein, the instructions being executable by a processor to cause the processor to perform operations. The operations include receiving parameters for a third-party content provider's campaign to present third-party content in conjunction with first-party content. The parameters include a bid amount for use in content auctions and one or more selection parameters configured to control when the bid amount is used in a content auction. The selection parameters also specify at least a first type of client device associated with the bid amount to which the third-party content is to be provided. The operations further include identifying bid amounts from other third-party content providers' campaigns that use similar selection parameters as the third-party content provider's campaign, each third-party content provider having a campaign associated with the first type of client device and another campaign associated with a second type of client device. The operations also include determining an aggregate measure of the bid amounts from the other third-party content providers' campaigns associated with the first type of client device. The operations yet further include determining an aggregate measure of the bid amounts from the other third-party content providers' campaigns associated with the second type of client device. The operations also include calculating a bid adjustment value that relates the aggregate measure of the bid amounts associated with the first type of client device to the aggregate measure of the bid amounts associated with the second type of client device. The operations additionally include providing the bid adjustment value for presentation to the third-party content provider to suggest a bid amount for the second type of client device.

These implementations are mentioned not to limit or define the scope of the disclosure, but to provide an example of an implementation of the disclosure to aid in understanding thereof. Particular implementations may be developed to realize one or more of the following advantages.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system in accordance with described implementations;

FIG. 2 is an illustration of an electronic display showing an example first-party webpage having third-party content;

FIG. 3 is an illustration of an electronic display showing exemplary first-party search results with third-party content;

FIG. 4 is a flow diagram of a process for suggesting a bid adjustment based on a device type, according to exemplary implementations;

FIG. 5 is a flow diagram of a process for determining a bid adjustment value for a campaign that uses topical categories as campaign parameters, according to various implementations; and

FIG. 6 is an illustration of a adjustment value being suggested, according to various implementations.

Like reference numbers and designations in the various drawings indicate like elements.

### DETAILED DESCRIPTION

According to some aspects of the present disclosure, a first-party content provider may allow a content selection service to determine which third-party content is to be provided in conjunction with the first-party provider's content. One or more third-party content providers may also use the content selection service to provide third-party content in conjunction with content from any number of first-party providers. In some cases, the content selection service may dynamically select which third-party content is presented in conjunction with a first-party provider's content. For example, a first-party webpage may display different third-party content during different visits to the webpage. The content selection service may determine which third-party content is to be provided based on any number of factors (e.g., whether the third-party content and first-party content relate to the same topic). For example, a third-party advertisement for golf clubs may appear on a webpage devoted to reviews of golf resorts. The content selection service may also conduct a content auction to select the third-party content to be provided from among the various third-party content providers.

In some cases, third-party content selected by a content selection service may be interactive. For example, the third-party content may be a playable video or audio file. In another example, the third-party content may be a clickable image (e.g., a hotlinked image) or hotlink configured to direct a web browser to an associated webpage when the image or hotlink is selected. In response to an interaction with the third-party content at a client device, the content selection service may receive an indication of the interaction. For example, the content selection service may receive an indication that a user has clicked on a third-party image and was redirected to the third-party content provider's website.

A content selection service may use data indicative of interactions with third-party content in a number of ways. The content selection service may allow third-party content providers to bid in an auction based on whether a user interacts with the selected content. For example, a third-party content provider may place a bid in the auction that corresponds to an agreement to pay a certain amount of money if a user interacts with the provider's content (e.g., the provider may agree to pay $3 if the user clicks on the provider's content). The content selection service may also use content interaction data to determine the performance of the first-party provider's content. For example, users may be more inclined to click on third-party content on certain webpages over others. Auction bids to place third-party content may be higher for high-performing websites, while the bids may be lower for low-performing websites.

For situations in which the systems discussed herein collect personal information about a user, or may make use of personal information, the user may be provided with an opportunity to control which programs or features collect such information, the types of information that may be collected (e.g., information about a user's social network, social actions or activities, a user's preferences, a user's current location, etc.), and/or how third-party content may be selected by a content selection service and presented to the user. Certain data, such as a device identifier, may be anonymized in one or more ways before it is stored or used, so that personally identifiable information is removed when generating parameters (e.g., demographic parameters) used by the content selection service to select third-party content. For example, a device identifier may be anonymized so that no personally identifiable information about its corresponding user can be determined from it. In another example, a user's geographic location may be generalized where location information is obtained (such as to a city, ZIP code, or state level), so that a precise location of the user cannot be determined. Thus, the user may have control over how information is collected about him or her and used by the content selection service.

In some implementations, a content selection service may be configured to allow a third-party content provider to create one or more campaigns, such as an advertising campaign. As part of a campaign, the third-party content provider may set any number of parameters that control how and when the third-party content provider participates in a content auction. For example, a campaign may include a bid amount on behalf of the content provider for use in a content auction. Other parameters may include selection parameters that control when the bid amount is used (e.g., whether or not the third-party content provider participates in a particular content auction). Exemplary selection parameters may include, but are not limited to, a set of one or more search keywords, a topical category, a geographic location of the client device on which the third-party content will be presented, or the type of client device on which the third-party content will be presented.

According to various implementations, a content selection service may be configured to provide suggested campaign parameters to a third-party content provider. For example, a content selection service may include various utilities that estimate the number of impressions (e.g., how many times the third-party content is presented to users) or clickthroughs (e.g., how many times users are likely to click on the third-party content when presented) based on different bid amounts. Such utilities may also include peer assessments that allow a third-party content provider to view aggregate metrics on the bid amounts used by similar third-party content providers. For example, assume that a third-party content provider creates a campaign to place a golf-related advertisement whenever a client device located in California searches for the phrase “best golf resort in California.” In such a case, the system may aggregate bidding data for other third-party content providers that also wish to provide content to devices located in California whenever golf-related searches are conducted. The aggregated bidding data may then be sent to the third-party content provider, to give the provider a better sense of how similar providers are bidding.

In some cases, a campaign may be specific to a type of device or may be a hybrid campaign that uses bids for different device platforms (e.g., different classifications based on device types). In some implementations, devices may be categorized as being either mobile devices (e.g., cellular phones) or desktop devices (e.g., a home computer). Tablet computing devices may be categorized under either category or their own category, but may typically fall under the desktop devices category, since many tablet devices are only WiFi enabled. A third-party content provider may be willing to bid more or less, depending on the device type. For example, a third-party content provider may be willing to bid more for desktop devices than for mobile devices, or vice-versa.

According to some implementations, a content selection service may suggest a bid amount to a third-party content provider for a particular type of device. For example, assume that a third-party content provider has selected a bid amount for desktop devices as part of a campaign. In such a case, the service may also suggest a bid amount for mobile devices. The suggested bid amount may be a raw monetary amount or may be relative to the bid amount for the other device type. For example, the suggested bid amount for mobile devices may be a suggested percentage increase or decrease of the provider's bid for desktop devices. A suggested bid amount may also be based on bid amounts from the provider's peers (e.g., other providers using similar selection parameters). In some implementations, the service may analyze bid amounts specified by content providers that have separate campaigns for mobile and desktop devices to determine a suggested bid adjustment value. For example, the service may notify a third-party content provider that similar providers decrease their bids for desktop devices by 25% when bidding for mobile devices.

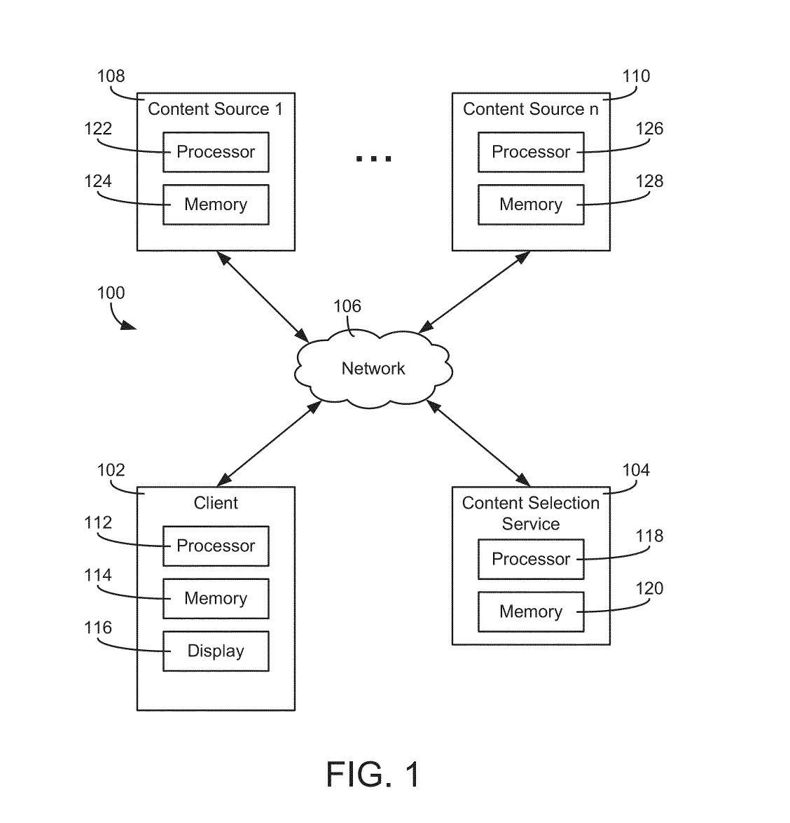

Referring to FIG. 1, a block diagram of a computer system 100 in accordance with a described implementation is shown. System 100 includes a client device 102 which communicates with other computing devices via a network 106. Client device 102 may execute a web browser or other application (e.g., a video game, a messenger program, a media player, a social networking application, etc.) to retrieve content from other devices over network 106. For example, client device 102 may communicate with any number of content sources 108, 110 (e.g., a first content source through nth content source). Content sources 108, 110 may provide webpage data and/or other content, such as images, video, and audio, to client device 102. Computer system 100 may also include a content selection service 104 configured to select third-party content to be provided to client device 102. For example, content source 108 may provide a first-party webpage to client device 102 that includes additional third-party content selected by content selection service 104.

Network 106 may be any form of computer network that relays information between client device 102, content sources 108, 110, and content selection service 104. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client device 102 may communicate wirelessly (e.g., via WiFi, cellular, radio, etc.) with a transceiver that is hardwired (e.g., via a fiber optic cable, a CATS cable, etc.) to other computing devices in network 106.

Client device 102 may be any number of different types of user electronic devices configured to communicate via network 106 (e.g., a laptop computer, a desktop computer, a tablet computer, a smartphone, a digital video recorder, a set-top box for a television, a video game console, combinations thereof, etc.). In some implementations, the type of client device 102 may be categorized as being a mobile device, a desktop device (e.g., a device intended to remain stationary or configured to primarily access network 106 via a local area network), or another category of electronic devices (e.g., tablet devices may be a third category, etc.). Client device 102 is shown to include a processor 112 and a memory 114, i.e., a processing circuit. Memory 114 may store machine instructions that, when executed by processor 112 cause processor 112 to perform one or more of the operations described herein. Processor 112 may include a microprocessor, ASIC, FPGA, etc., or combinations thereof. Memory 114 may include, but is not limited to, electronic, optical, magnetic, or any other storage or transmission device capable of providing processor 112 with program instructions. Memory 114 may include a floppy disk, CD-ROM, DVD, magnetic disk, memory chip, ROM, RAM, EEPROM, EPROM, flash memory, optical media, or any other suitable memory from which processor 112 can read instructions. The instructions may include code from any suitable computer programming language such as, but not limited to, C, C++, C#, Java, JavaScript, Perl, HTML, XML, Python and Visual Basic.

Client device 102 may include one or more user interface devices. A user interface device may be any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to the housing of client device 102 (e.g., a built-in display, microphone, etc.) or external to the housing of client device 102 (e.g., a monitor connected to client device 102, a speaker connected to client device 102, etc.), according to various implementations. For example, client device 102 may include an electronic display 116, which displays webpages and other data received from content sources 108, 110 and/or content selection service 104. In various implementations, display 116 may be located inside or outside of the same housing as that of processor 112 and/or memory 114. For example, display 116 may be an external display, such as a computer monitor, television set, or any other stand-alone form of electronic display. In other examples, display 116 may be integrated into the housing of a laptop computer, mobile device, or other form of computing device having an integrated display.

Content sources 108, 110 may be one or more electronic devices connected to network 106 that provide content to devices connected to network 106. For example, content sources 108, 110 may be computer servers (e.g., FTP servers, file sharing servers, web servers, etc.) or combinations of servers (e.g., data centers, cloud computing platforms, etc.). Content may include, but is not limited to, webpage data, a text file, a spreadsheet, images, search results, other forms of electronic documents, and applications executable by client device 102. For example, content source 108 may be an online search engine that provides search result data to client device 102 in response to a search query. In another example, content source 110 may be a first-party web server that provides webpage data to client device 102 in response to a request for the webpage. Similar to client device 102, content sources 108, 110 may include processing circuits comprising processors 122, 126 and memories 124, 128, respectively, that store program instructions executable by processors 122, 126. For example, the processing circuit of content source 108 may include instructions such as web server software, FTP serving software, and other types of software that cause content source 108 to provide content via network 106.

According to various implementations, content sources 108, 110 may provide webpage data to client device 102 that includes one or more content tags. In general, a content tag may be any piece of webpage code associated with the action of including third-party content with a first-party webpage. For example, a content tag may define a slot on a webpage for third-party content, a slot for out of page third-party content (e.g., an interstitial slot), whether third-party content should be loaded asynchronously or synchronously, whether the loading of third-party content should be disabled on the webpage, whether third-party content that loaded unsuccessfully should be refreshed, the network location of a content source that provides the third-party content (e.g., content sources 108, 110, content selection service 104, etc.), a network location (e.g., a URL) associated with clicking on the third-party content, how the third-party content is to be rendered on a display, a command that causes client device 102 to set a browser cookie (e.g., via a pixel tag that sets a cookie via an image request), one or more keywords used to retrieve the third-party content, and other functions associated with providing third-party content with a first-party webpage. For example, content source 108 may provide webpage data that causes client device 102 to retrieve third-party content from content selection service 104. In another implementation, content may be selected by content selection service 104 and provided by content source 108 as part of the first-party webpage data sent to client device 102. In a further example, content selection service 104 may cause client device 102 to retrieve third-party content from a specified location, such as memory 114 or content sources 108, 110.

Content selection service 104 may also be one or more electronic devices connected to network 106. Content selection service 104 may be a computer server (e.g., FTP servers, file sharing servers, web servers, etc.) or a combination of servers (e.g., a data center, a cloud computing platform, etc.). Content selection service 104 may have a processing circuit including a processor 118 and a memory 120 that stores program instructions executable by processor 118. In cases in which content selection service 104 is a combination of computing devices, processor 118 may represent the collective processors of the devices and memory 120 may represent the collective memories of the devices.

Content selection service 104 may be configured to select third-party content for client device 102 (i.e., content selection service 104 may provide a third-party content selection service). In one implementation, the selected third-party content may be provided by content selection service 104 to client device 102 via network 106. For example, content source 110 may upload the third-party content to content selection service 104. Content selection service 104 may then provide the third-party content to client device 102 to be presented in conjunction with first-party content provided by any of content sources 108, 110. In other implementations, content selection service 104 may provide an instruction to client device 102 that causes client device 102 to retrieve the selected third-party content (e.g., from memory 114 of client device 102, from content source 110, etc.). For example, content selection service 104 may select third-party content to be provided as part of a first-party webpage being visited by client device 102 or within a first-party application being executed by client device 102 (e.g., within a game, messenger application, etc.).

In some implementations, content selection service 104 may be configured to select content based on a device identifier associated with client device 102. In general, a device identifier refers to any form of data that may be used to represent a device or software that receives content selected by content selection service 104. In some implementations, a device identifier may be associated with one or more other device identifiers (e.g., a device identifier for a mobile device, a device identifier for a home computer, etc.). Device identifiers may include, but are not limited to, cookies, device serial numbers, user profile data, or network addresses. For example, a cookie set on client device 102 may be used to identify client device 102 to content selection service 104.

Content selection service 104 may be configured to allow the user of client device 102 to control which information about the user is collected and used by content selection service 104 via a device identifier. In addition, to the extent that content selection service 104 does collect and use information about the user, the data may be anonymized such that the user's identity cannot be determined by analyzing the collected data. In other words, the user of client device 102 may control what types of information about the user is collected by content selection service 104 and how the information is used. In one embodiment, the user of client device 102 may set one or more preferences (e.g., as part of an online profile) that control how content selection service 104 collects and uses information about the user. In another embodiment, content selection service 104 may set a cookie or other device identifier on client device 102 that signifies that the user of client device 102 has elected not to allow content selection service 104 to store information regarding him or her.

If the user of client device 102 has elected to allow content selection service 104 to use information regarding him or her, content selection service 104 may use history data associated with a device identifier to select relevant content for the corresponding user. History data may be any data associated with a device identifier that is indicative of an online event (e.g., visiting a webpage, interacting with presented content, conducting a search, making a purchase, downloading content, etc.). Based in part on the analyzed history data, content selection service 104 may select third-party content to be provided in conjunction with first-party content (e.g., as part of a displayed webpage, as a pop-up, within a video game, within another type of application, etc.). Additional data associated with a device identifier may include, but is not limited to, the device type of client device 102 (e.g., whether client device 102 is a desktop or mobile device), the location of client device 102, or a search query generated by client device 102. For example, content selection service 104 may select third-party content to be provided as part of a first-party webpage or in conjunction with search results from one of content sources 108, 110.

Content selection service 104 may analyze the history data associated with a device identifier to identify one or more topics that may be of interest. For example, content selection service 104 may perform text and/or image analysis on a webpage from content source 108, to determine one or more topics of the webpage. In some implementations, a topic may correspond to a predefined interest category used by content selection service 104. For example, a webpage devoted to the topic of golf may be classified under the interest category of sports. In some cases, interest categories used by content selection service 104 may conform to a taxonomy (e.g., an interest category may be classified as falling under a broader interest category). For example, the interest category of golf may be /Sports/Golf, /Sports/Individual Sports/Golf, or under any other hierarchical category. Similarly, content selection service 104 may analyze the content of a first-party webpage accessed by client device 102 to identify one or more topical categories for the webpage. For example, content selection service 104 may use text or image recognition on the webpage to determine that the webpage is devoted to the topical category of /Sports/Golf.

Content selection service 104 may receive history data indicative of one or more online events associated with a device identifier. In implementations in which a content tag causes client device 102 to request content from content selection service 104, such a request may include a device identifier for client device 102 and/or additional information (e.g., the webpage being loaded, the referring webpage, etc.). For example, content selection service 104 may receive and store history data regarding whether or not third-party content provided to client device 102 was selected using an interface device (e.g., the user of client device 102 clicked on a third-party hyperlink, third-party image, etc.). Content selection service 104 may store such data to record a history of online events associated with a device identifier. In some cases, client device 102 may provide history data to content selection service 104 without first executing a content tag. For example, client device 102 may periodically send history data to content selection service 104 or may do so in response to receiving a command from a user interface device. In some implementations, content selection service 104 may receive history data from content sources 108, 110. For example, content source 108 may store history data regarding web transactions with client device 102 and provide the history data to content selection service 104.

Content selection service 104 may apply one or more weightings to an interest or product category, to determine whether the category is to be associated with a device identifier. For example, content selection service 104 may impose a maximum limit to the number of product or interest categories associated with a device identifier. The top n-number of categories having the highest weightings may then be selected by content selection service 104 to be associated with a particular device identifier. A category weighting may be based on, for example, the number of webpages visited by the device identifier regarding the category, when the visits occurred, how often the topic of the category was mentioned on a visited webpage, or any online actions performed by the device identifier regarding the category. For example, topics of more recently visited webpages may receive a higher weighting than webpages that were visited further in the past. Categories may also be subdivided by the time periods in which the webpage visits occurred. For example, the interest or product categories may be subdivided into long-term, short-term, and current categories, based on when the device identifier visited a webpage regarding the category.

Content selection service 104 may be configured to conduct a content auction among third-party content providers to determine which third-party content is to be provided to client device 102. For example, content selection service 104 may conduct a real-time content auction in response to client device 102 requesting first-party content from one of content sources 108, 110 or executing a first-party application. Content selection service 104 may use any number of factors to determine the winner of the auction. For example, the winner of a content auction may be based in part on the third-party provider's bid and/or a quality score for the third-party provider's content (e.g., a measure of how likely the user of client device 102 is to click on the content). In other words, the highest bidder is not necessarily the winner of a content auction conducted by content selection service 104, in some implementations.

Content selection service 104 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at client device 102. In other words, the bid amount may be on a cost per impression or cost per thousand impressions (CPM) basis. In further cases, a bid amount may correspond to a specified action being performed in response to the third-party content being presented at a client device. For example, a bid amount may be a monetary amount that the third-party content provider is willing to pay, should their content be clicked on at the client device, thereby redirecting the client device to the provider's webpage. In other words, a bid amount may be a cost per click (CPC) bid amount. In another example, the bid amount may correspond to an action being performed on the third-party provider's website, such as the user of client device 102 making a purchase. Such bids are typically referred to as being on a cost per acquisition (CPA) or cost per conversion basis.

A campaign created via content selection service 104 may also include selection parameters that control when a bid is placed on behalf of a third-party content provider in a content auction. If the third-party content is to be presented in conjunction with search results from a search engine, for example, the selection parameters may include one or more sets of search keywords. For example, the third-party content provider may only participate in content auctions in which a search query for “golf resorts in California” is sent to a search engine. Other exemplary parameters that control when a bid is placed on behalf of a third-party content provider may include, but are not limited to, a topic identified using a device identifier's history data (e.g., based on webpages visited by the device identifier), the topic of a webpage or other first-party content with which the third-party content is to be presented, a geographic location of the client device that will be presenting the content, or a geographic location specified as part of a search query. In some cases, a selection parameter may designate a specific webpage, website, or group of websites with which the third-party content is to be presented. For example, an advertiser selling golf equipment may specify that they wish to place an advertisement on the sports page of an particular online newspaper.

Content selection service 104 may also be configured to suggest a bid amount to a third-party content provider when a campaign is created or modified. In some implementations, the suggested bid amount may be based on aggregate bid amounts from the third-party content provider's peers (e.g., other third-party content providers that use the same or similar selection parameters as part of their campaigns). For example, a third-party content provider that wishes to place an advertisement on the sports page of an online newspaper may be shown an average bid amount used by other advertisers on the same page. The suggested bid amount may facilitate the creation of bid amounts across different types of client devices, in some cases. In some implementations, the suggested bid amount may be sent to a third-party content provider as a suggested bid adjustment value. Such an adjustment value may be a suggested modification to an existing bid amount for one type of device, to enter a bid amount for another type of device as part of the same campaign. For example, content selection service 104 may suggest that a third-party content provider increase or decrease their bid amount for desktop devices by a certain percentage, to create a bid amount for mobile devices.

In some implementations, content selection service 104 may analyze bid amounts from different third-party content providers to generate a suggested bid adjustment value. Content selection service 104 may, for example, execute a batch job on a periodic basis to assess how third-party content providers are bidding for different device types. For example, content selection service 104 may analyze bids on a weekly basis to determine metrics on how the third-party content providers are bidding. In some implementations, content selection service 104 may determine aggregate measures of the bids, broken down by device type. For example, content selection service 104 may separately determine average bids for mobile and desktop devices and use these averages to generate a suggested bid amount for a third-party content provider. The aggregate measures may be generated using data for third-party content providers that have separate campaigns for mobile and desktop devices, in some cases. Content selection service 104 may also determine the aggregate measures across different selection parameters, to tailor a suggested bid amount or bid adjustment value to a third-party content provider based on the bids used by the provider's peers.

As a non-limiting example of content selection service 104 suggesting a bid adjustment value, assume that a third-party content provider is an advertiser selling golf equipment and is creating an advertising campaign via content selection service 104. During creation of the campaign, assume that the provider specifies that they wish to present a link to their online store to desktop devices located in California that search for the terms “golf equipment stores in California.” The third-party content provider may also specify that they're willing to pay $5 each time a client device is redirected to the provider's online store when the link is clicked. In response, content selection service 104 may retrieve a bid adjustment value that corresponds to the campaign's parameters. For example, content selection service 104 may determine that the average ratio of mobile-related bids to desktop-related bids is 3/4 for third-party content providers that provide content to devices that search for golf equipment in California. Content selection service may then suggest that the third-party content provider creating the campaign use a bid amount that is 25% less than the provider's bid amount for desktop devices (e.g., 25% less than the $5 bid amount for desktop devices).

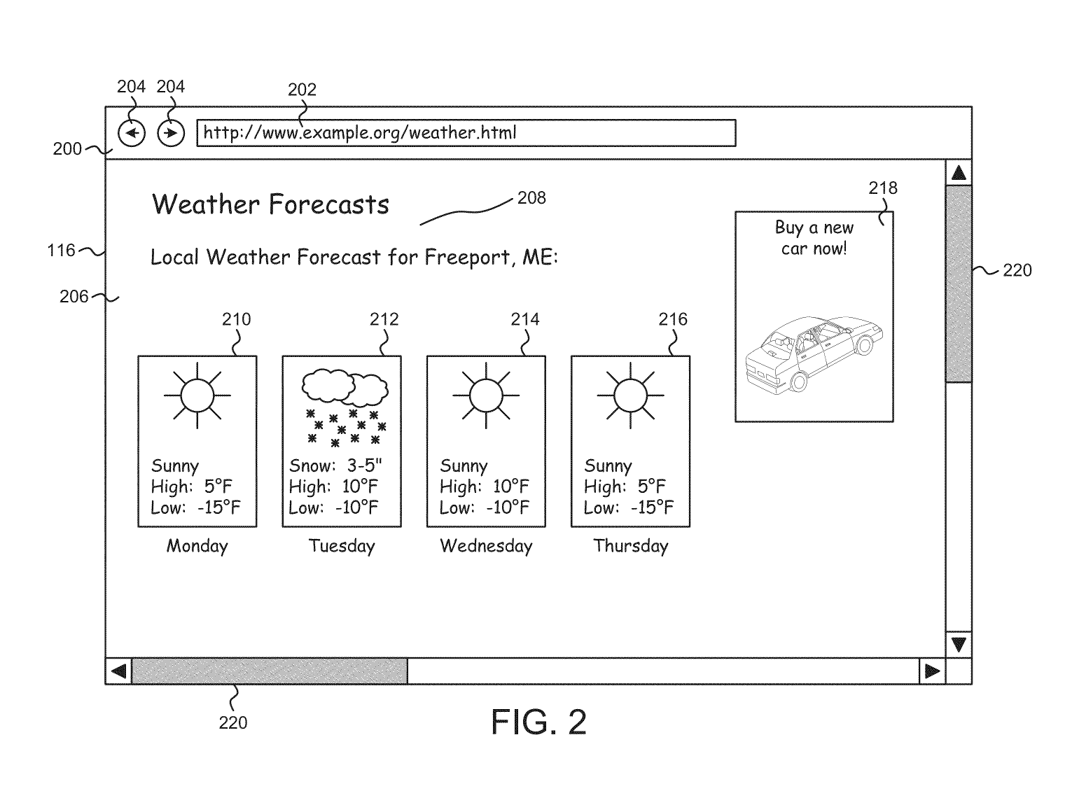

Referring now to FIG. 2, an illustration is shown of electronic display 116 displaying an example first-party webpage 206. Electronic display 116 is in electronic communication with processor 112 which causes visual indicia to be displayed on electronic display 116. As shown, processor 112 may execute a web browser 200 stored in memory 114 of client device 102, to display indicia of content received by client device 102 via network 106. In other implementations, another application executed by client device 102 may incorporate some or all of the functionality described with regard to web browser 200 (e.g., a video game, a chat application, etc.).

Web browser 200 may operate by receiving input of a uniform resource locator (URL) via a field 202 from an input device (e.g., a pointing device, a keyboard, a touch screen, etc.). For example, the URL, http://www.example.org/weather.html, may be entered into field 202. Processor 112 may use the inputted URL to request data from a content source having a network address that corresponds to the entered URL. In other words, client device 102 may request first-party content accessible at the inputted URL. In response to the request, the content source may return webpage data and/or other data to client device 102. Web browser 200 may analyze the returned data and cause visual indicia to be displayed by electronic display 116 based on the data.

In general, webpage data may include text, hyperlinks, layout information, and other data that may be used to provide the framework for the visual layout of first-party webpage 206. In some implementations, webpage data may be one or more files of webpage code written in a markup language, such as the hypertext markup language (HTML), extensible HTML (XHTML), extensible markup language (XML), or any other markup language. For example, the webpage data in FIG. 2 may include a file, “weather.html” provided by the website, “www.example.org.” The webpage data may include data that specifies where indicia appear on first-party webpage 206, such as text 208. In some implementations, the webpage data may also include additional URL information used by web browser 200 to retrieve additional indicia displayed on first-party webpage 206. For example, the file, “weather.html,” may also include one or more instructions used by processor 112 to retrieve images 210-216 from their respective content sources.

Web browser 200 may include a number of navigational controls associated with first-party webpage 206. For example, web browser 200 may be configured to navigate forward and backwards between webpages in response to receiving commands via inputs 204 (e.g., a back button, a forward button, etc.). Web browser 200 may also include one or more scroll bars 220, which can be used to display parts of first-party webpage 206 that are currently off-screen. For example, first-party webpage 206 may be formatted to be larger than the screen of electronic display 116. In such a case, the one or more scroll bars 220 may be used to change the vertical and/or horizontal position of first-party webpage 206 on electronic display 116.

First-party webpage 206 may be devoted to one or more topics. For example, first-party webpage 206 may be devoted to the local weather forecast for Freeport, Me. In some implementations, a content selection server, such as content selection service 104, may analyze the contents of first-party webpage 206 to identify one or more topics. For example, content selection service 104 may analyze text 208 and/or images 210-216 to identify first-party webpage 206 as being devoted to weather forecasts. In some implementations, webpage data for first-party webpage 206 may include metadata that identifies a topic.

In various implementations, content selection service 104 may select some of the content presented on first-party webpage 206 (e.g., an embedded image or video, etc.) or in conjunction with first-party webpage 206 (e.g., in a pop-up window or tab, etc.). For example, content selection service 104 may select third-party content 218 to be included on webpage 206. In some implementations, one or more content tags may be embedded into the code of webpage 206 that defines a content field located at the position of third-party content 218. Another content tag may cause web browser 200 to request additional content from content selection service 104, when first-party webpage 206 is loaded. Such a request may include one or more keywords, a device identifier for client device 102, or other data used by content selection service 104 to select content to be provided to client device 102. In response, content selection service 104 may select third-party content 218 for presentation on first-party webpage 206.

Content selection service 104 may select third-party content 218 (e.g., an advertisement) by conducting a content auction, in some implementations. Content selection service 104 may also determine which third-party content providers compete in the auction based in part on campaign parameters set by the providers. For example, only content providers that specified a topic that matches that of webpage 206, an interest category of a device identifier accessing webpage 206, or webpage 206 specifically may compete in the content auction. Based on bidding parameters for these third-party content providers, content selection service 104 may compare their bid amounts, quality scores, and/or other values to determine the winner of the auction and select third-party content 218 for presentation with webpage 206.

In some implementations, content selection service 104 may provide third-party content 218 directly to client device 102. In other implementations, content selection service 104 may send a command to client device 102 that causes client device 102 to retrieve third-party content 218. For example, the command may cause client device 102 to retrieve third-party content 218 from a local memory, if third-party content 218 is already stored in memory 114, or from a networked content source. In this way, any number of different pieces of content may be placed in the location of third-party content 218 on first-party webpage 206. In other words, one user that visits first-party webpage 206 may be presented with third-party content 218 and a second user that visits first-party webpage 206 may be presented with different content. Other forms of content (e.g., an image, text, an audio file, a video file, etc.) may be selected by content selection service 104 for display with first-party webpage 206 in a manner similar to that of third-party content 218. In further implementations, content selected by content selection service 104 may be displayed outside of first-party webpage 206. For example, content selected by content selection service 104 may be displayed in a separate window or tab of web browser 200, may be presented via another software application (e.g., a text editor, a media player, etc.), or may be downloaded to client device 102 for later use.

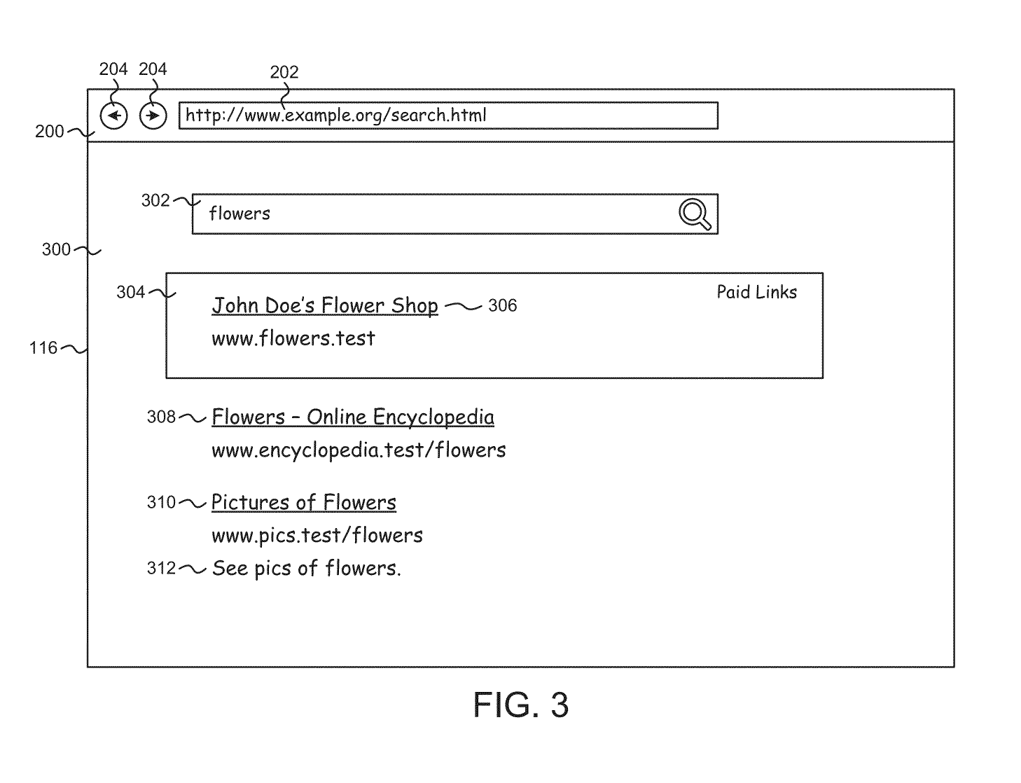

Referring now to FIG. 3, an illustration is shown of electronic display 116 showing first-party search results with third-party content. Similar to webpage 206 in FIG. 2, client device 102 may access a first-party search engine via network 106 by executing a web browser 200. In other implementations, the search engine may provide search results for display by client device 102 within a stand-alone application. For example, a navigation application executed by client device 102 may include a search feature that allows search results from the search engine to be presented within the application.

As shown, the first-party search engine accessed by client device 102 may provide a webpage 300 to client device 102 that is configured to allow for searches and search results to be updated on the fly. For example, webpage 300 may include a search field 302 that receives a search query and webpage 300 may also display search results obtained using the query. In other implementations, search field 302 may be displayed separately from the search results (e.g., search field 302 and the search results may appear on different webpages, screens, etc.). Search field 302 is generally configured to receive one or more search terms to be searched by the search engine. For example, the search term “flowers” may be entered into search field 302 and used to search for links to online resources devoted to flowers. A search query may be entered into search field 302 via a touch screen display, keyboard, a microphone (e.g., via voice recognition), or another user interface device of client device 102.

In response to receiving the search query entered into search field 302, the search engine may retrieve any number of links to websites or other online services regarding the query. For example, the search engine may retrieve the URLs of websites devoted to the topic of flowers and provide them as hyperlinks 308, 310 on webpage 300 as search results. In some implementations, the search engine may maintain an index of keywords used on webpages or other resources. Search results may then be ordered by the search engine based on the relevancy of the indexed webpages relative to the search query. A summary of the webpage or other resource may also be provided on webpage 300 by the search engine. For example, hyperlink 310 may have an associated description 312 that gives more detail about the linked webpage. Since hyperlinks 308, 310 are presented as search results based solely on their relevancy to the search query, they may be considered first-party content.

In addition to webpage 300 including hyperlinks 308, 310 as search results, webpage 300 may also include third-party content 304 selected by content selection service 104. Third-party content 304 may be, in one example, a hyperlink 306 to a third-party content provider's website. Third-party content 304 may also identify itself as being third-party content, such as including a notification that the hyperlink is a paid link. Other exemplary forms of third-party content that may be presented in conjunction with search results may include a location (e.g., the location of the nearest florist to client device 102) or links to perform online actions, such as playing a piece of media content.

Content selection service 104 may conduct a content auction to select third-party content 304. In response to the search query entered into search field 302, content selection service 104 may first determine which third-party content providers are to compete in a content auction. For example, only third-party content providers that specify the search term “flowers” may participate in the content auction. Another exemplary campaign parameter that may also be used to control which third-party content providers participate in the auction includes the geographic location of client device 102. Such a geographic location may correspond to a particular city, zip code, state, country, or other area. For example, a third-party advertiser located in Great Britain may only be interested in advertising to client devices located there and not in the United States of America. The device type of client device 102 may also be used as a further parameter to control which third-party content providers participate in the content auction. For example, only certain providers may participate if client device is a mobile device. Based on the bid amounts of the providers that participate in the content auction and other factors, content selection service 104 may select third-party content 304 for presentation with the search results on webpage 300.

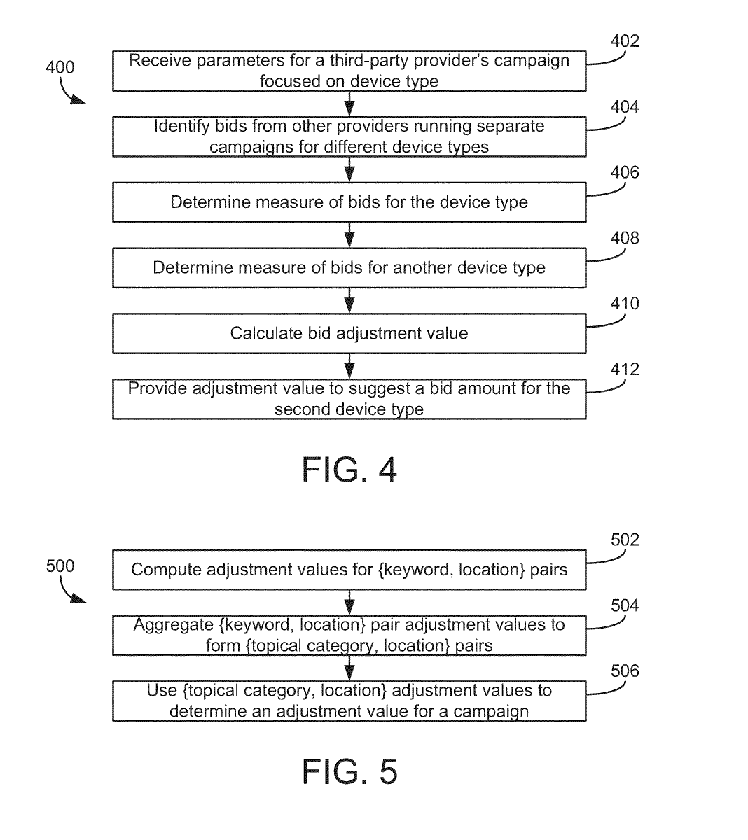

Referring now to FIG. 4, a flow diagram of a process 400 for suggesting a bid adjustment based on a device type is shown, according to exemplary implementations. In general, the suggested bid adjustment may represent a suggested bid amount for one device type relative to another. For example, it may be suggested that a third-party content provider increase or decrease a bid amount for desktop devices by a certain percentage, to provide content to mobile devices. In further implementations, a bid amount itself may be suggested by multiplying the bid amount for the other device type by the suggested bid adjustment value. Process 400 may be performed by one or more computing devices associated with a content selection service. For example, process 400 may be implemented by content selection service 104 shown in FIG. 1.

Process 400 includes receiving parameters for a third-party content provider's campaign focused on a device type (block 402). In some implementations, a device type may correspond to a desktop or home device (e.g., a computing device configured to access a local network, such as a home or office LAN) or a mobile device (e.g., a computing device configured to access a cellular or satellite-based network). In some cases, a tablet device may be classified as being a desktop device for purposes of a campaign. In other cases, a tablet device may have its own classification separate from desktop and mobile devices.

The received parameters may include bid-related parameters (e.g., parameters that control how much the third-party content provider is willing to spend in a content auction) and/or selection parameters (e.g., parameters that control in which content auctions the provider participates). Bid-related parameters may include, but are not limited to, minimum, maximum, or target bid amounts, budgetary data (e.g., daily, weekly, etc., budgets), or other parameters that control the financial costs for the third-party content provider associated with their content being placed. In some implementations, the bid-related parameters may be associated with a selection parameter that specifies a particular type of device. For example, a bid amount in a campaign may be used to participate in content auctions for mobile devices or desktop devices. Additional selection criteria that control in which auctions the provider participates may include, but are not limited to, one or more sets of search terms, a topic of a visited webpage, an interest category associated with a device identifier, or a geographic location of the client device to which the third-party content is to be provided.

In one example, campaign parameters may be received as part of a third-party content provider beginning the creation or modification of a campaign. For example, the third-party content provider may specify that they wish to bid a maximum of $5 per click whenever a desktop device located in the United States of America searches for the terms “online florists.”

Process 400 includes identifying bids from other providers running separate campaigns for different device types (block 404). For example, bids may be identified from third-party content providers that run separate campaigns for mobile and desktop devices. In some cases, it can be assumed that providers that split their mobile and desktop campaigns have optimized each campaign separately. Thus, each campaign's bids may reflect bid amounts that achieve good returns on investments (ROIs) for the different devices. The bid amounts may be current or historical bid amounts, according to various implementations. For example, only bid amounts used in the past week or month may be identified, while older bid amounts may be ignored. In further implementations, bid amounts from third-party content providers that mix device types in a single campaign may also be identified in addition to, or in lieu of, bid amounts from third-party content providers that split their campaigns based on device type.

Third-party content providers that use separate campaigns for different device types may be identified in any number of different ways. In some implementations, campaigns attributable to the same CustomerID may be analyzed to identify campaigns from the same third-party content provider that created separate campaigns for different device types. However, some third-party content providers may create separate CustomerIDs for different types of campaigns. In such a case, a higher level identifier, such as DivisionID (e.g., another identifier that has one or more associated campaigns or CustomerIDs) may be analyzed instead to identify campaigns from the same provider that are focused on different device types. In some cases, a CustomerID or DivisionID that has no desktop-only or mobile-only campaigns, or neither, may be ignored by the system when determining a suggested bid amount or suggested bid adjustment value.

Process 400 may include determining a measure of bids for the device type specified in block 402 (block 406). The measure may be for bids associated with mobile devices, desktop devices, or any other category of electronic devices. The measure may be any form of statistical measure, in various implementations. For example, the measure may be the mean, median, or mode of the identified bids. In some implementations, the geometric mean may be used to aggregate and measure the bids. A weighting may also be used based on the amount spent per DivisionID or based on the amount spent per campaign, to determine the measure. Such a weighting may be used, for example, to emphasize the bids of third-party content providers that spent the most.

Process 400 may also include determining a measure of bids for a different device type than the one specified in block 402 (block 408). For example, assume that the device type from block 402 is a desktop device. In such a case, a measure of bids for mobile devices may also be determined, allowing for bids associated with each device type to be compared across the provider's peers. Similar to block 406, the measure of bids for the other device type may be any form of statistical measure. In various implementations, the measure may be the mean, median, or mode of the identified bids. For example, weighting values, such as those used to determine a geometric mean, may be used to emphasize the bids of those peer providers that spent the most or provide another emphasis to certain bids.

Process 400 may include calculating a bid adjustment value (block 410). Once measures of the bids for a provider's peers have been determined for different device types, these measures may be used to calculate a bid adjustment value. In some implementations, the bid adjustment value may be the ratio of average bid for desktop devices to the average bid for mobile devices. In other implementations, the bid adjustment value may be the ratio of average bids for mobile devices to the average bid for desktop devices. For example, assume that the average peer content provider bids $4 for mobile devices and $5 for desktop devices. In such a case, the computed bid adjustment value would be 80%, thereby suggesting to a third-party content provider that his or her bids for desktop devices should be lowered by 20% for mobile devices. In further implementations, the provider's bid for mobile or desktop devices may instead be multiplied by the calculated bid adjustment value, thereby suggesting a dollar amount for the other bid instead of a ratio or percentage.

According to various implementations, blocks 404-410 may be repeated any number of times to determine the finalized bid adjustment value. In some implementations, bid adjustment values may be determined for any number of different datasets and combined to form different adjustment values across the different possible campaign parameters. For example, bid adjustment values may first be determined for each {keyword, location} pair specified by the third-party content providers. These bid adjustment values may then be aggregated to form bid adjustment values for different {topical category, location} pairs. For example, assume that different third-party providers specify the search keyword of “golf resorts,” “golf hotels,” or “golf vacations” as part of their campaigns for the United States of America. While different, each set may still relate to the same topical category. Thus, the bid adjustment values for these sets may be aggregated to form a new bid adjustment value for the topical category regarding golf-related vacations. Any {topical category, location} pairs then used by a third-party content provider in a campaign may be used to retrieve the corresponding bid adjustment values, which may be used to form a finalized bid adjustment value for the provider. For example, assume that an advertiser's campaign uses topical categories regarding both golf-related vacations and tennis-related vacations in the United States of America. In such a case, the bid adjustment values for each of these topical categories may be combined to form a finalized bid adjustment value for the provider. Bid adjustment values for other sets of bids may also be determined in a similar manner as {keyword, location} pairs. For example, another grouping that may be used is {PublisherID, location} pairs, where PublisherID is a unique identifier for a first-party content provider. Such a grouping may be used to represent bids to place third-party content on a particular first-party content provider's website or group of websites.

A bid adjustment value may be calculated at any time, in various implementations. In some implementations, a new, finalized bid adjustment value may be determined on the fly whenever a third-party content provider creates or modifies a campaign. In other implementations, bid adjustment values used to calculate the provider's finalized adjustment value may be calculated on a periodic basis, such as daily, weekly, or monthly. For example, bid adjustment values for {keyword, location} pairs, {topical category, location} pairs, {PublisherID, location} pairs, etc., may be calculated via a batch job that runs on a periodic or aperiodic basis, to reduce the amount of computing resources consumed.

Process 400 may include providing the adjustment value to suggest a bid amount for the second device type (block 412). Once a finalized bid adjustment value has been determined for a third-party content provider's campaign, it may be provided to a computing device for presentation to the third-party content provider. For example, a screen may be presented to the provider that suggests that the provider decrease his or her bids for desktop devices by 25% when bidding on mobile devices. Alternatively, an actual bid amount for the second device may be provided as a suggestion (e.g., the system may alternatively calculate the suggested bid using the bid adjustment value and the provider's bid for the first type of device).

Referring now to FIG. 5, a flow diagram is shown of a process 500 for determining a bid adjustment value for a campaign that uses topical categories as campaign parameters, according to various implementations. Process 500 may be implemented by the same or similar computing devices as process 400. In some cases, process 500 may be used to implement part of process 400. For example, process 500 may be used to implement blocks 404-410 of process 400. While process 500 demonstrates the calculation of a finalized bid adjustment value using {keyword, location} pairs as the most granular sets of bidding data, other sets of bid amounts broken down by different campaign parameters may be used in other implementations. For example, {ProviderId, location} pairs may be used in some implementations to determine a finalized bid adjustment value for a third-party content provider's campaign. Further examples include campaign parameters that are not broken down by geographic location, campaign parameters devoted to topical interest categories, and campaign parameters that take into account social networking actions. In alternate implementations, process 500 may be applied at any other level of grouping used to group data associated with an account of a third-party content provider. For example, a campaign may include multiple content groups (e.g., sets of keywords, content, bids, etc.), each group devoted to a particular good or service offered by the content provider. In such a case, process 500 may be applied at the content group level, at the campaign level, or both.

Process 500 may include computing bid adjustment values for {keyword, location} pairs (block 502). In general, bids may be first identified according to which keywords and locations are used by the third-party content providers. For example, consider the pair of {“flower,” “US”} which represents searches made for the term “flowers” by devices located in the United States of America. In one implementation, third-party content providers that use such campaign parameters may be identified as follows:

TABLE 1

| | | |
|---|---|---|
| {keyword, location} = | Division 1: BM(div1) | Have both desktop only |
| {“flower,” US} | | and mobile only |
| | | campaigns |
| | . . . | Have both desktop only |
| | | and mobile only |
| | | campaigns |
| | Division N: BM(divN) | Have both desktop only |
| | | and mobile only |
| | | campaigns |
| | Other Divisions | No desktop only |
| | | campaigns, no mobile only |
| | | campaigns, or neither |

As shown in the above table, bid adjustment values (e.g., BM(div1) to BM(divN)) may be determined for each third-party content provider that has both mobile-only and desktop-only campaigns for a given {keyword, location} pair. In some implementations, these content providers may be identified at the division level, instead of at the CustomerID level, to include data from providers that use different CustomerIDs. In other implementations, CustomerIDs may instead be used to identify third-party content providers that have separate campaigns for desktop and mobile devices. Third-party content providers that have no desktop-only campaigns, no mobile-only campaigns, or neither, may or may not be ignored for purposes of determining a bid adjustment value for a {keyword, location} pair. The bid adjustment value for each identified third-party content provider (e.g., BM(div1) to BM(divN)) may be determined as the ratio of the provider's bids for desktop devices to mobile devices in their separate campaigns, or vice-versa. For example, a content provider that bids $5 for desktop devices and $4 for mobile devices may have a computed bid adjustment value of 4/5=80%. In further implementations, a bid adjustment value for a particular keyword for a division may be calculated as follows:

$$BM ( {Div}_{i} ) = \frac{[ \frac{{\sum }_{j = 1}^{M} {w}_{j} * Bid ( {MCampaign}_{j} )}{{\sum }_{j = 1}^{M} {w}_{j}} ]}{[ \frac{{\sum }_{i = 1}^{N} {w}_{i} * Bid ( {DCampaign}_{i} )}{{\sum }_{i = 1}^{N} {w}_{i}} ]}$$

where Bid(MCampaignⱼ) is the bid used in the jth mobile-only campaign, Bid(DCampaignᵢ) is the bid used in the ith desktop-only campaign, and w is a weighting value applied to each bid. In some implementations, the weighting value may correspond to the overall amount spent by the provider, thereby adding greater emphasis to the bids of third-party content providers that are heavily invested in providing their content to client devices. In other implementations, the weighting value may be based on the number of impressions, clicks, or spend by the providers on mobile, desktop, or both platforms.

According to various implementations, the bid adjustment values for the identified third-party content providers may be used to form an aggregate measure that represents all of the providers for the {keyword, location} pair that have separate mobile and desktop campaigns. In some implementations, a geometric mean may be calculated as follows:

$$BM ( kw ) = {( \prod {BM ( {Div}_{i} )}^{{w}_{i}} )}^{1 / {\sum }_{i = 1}^{N} {w}_{i}}$$

where BM(kw) is the bid adjustment value for a given keyword or set of keywords (e.g., a bid multiplier value), BM(Divᵢ) is the bid adjustment value from a particular third-party content provider, and wᵢ is a weighting value assigned to the ith content provider. Similar to the weightings used to determine the adjustment values at the division level, the weightings used to determine the bid adjustment value for the {keyword, location} pair may be based on the provider's impressions, clicks, or spend across one or both device types. In other implementations, the weighting may be based entirely on the amount spent for mobile devices, if the suggested bid or adjustment value is suggesting a bid for mobile devices. To make the computations numerically stable, the following formula may be used alternatively to determine the bid adjustment value for the {keyword, location} pair:

$$log [ BM ( kw ) ] = \frac{1}{{\sum }_{i = 1}^{1} {w}_{i}} ( {\sum }_{i = 1}^{N} {w}_{i} * log [ BM ( {Div}_{i} ) ] )$$

where BM(Divᵢ) is the bid adjustment value for the ith division.

Process 500 may include aggregating bid adjustment values for the {keyword, location} pairs to form {topical category, location} pairs (block 504). Sometimes referred to as “verticals,” topical categories may represent the topical category underlying any number of different sets of keywords. For example, the terms “hole in one,” “birdie,” and “eagle,” may all relate to the same topical category of golf. Their corresponding bid adjustment values calculated in block 502 may then be aggregated to represent the bid adjustment value for the topical category. In some implementations, a bid adjustment value for a {topical category, location} pair (e.g., mᵥ) may be determined as follows:

$$log [ {m}_{v} ] = \frac{{\sum }_{k}^{N} {s}_{k} * {d}_{k} * log ( {m}_{k} )}{{{\sum }_{k}}^{N} {s}_{k} * {d}_{k}}$$

where mₖ is a keyword multiplier (e.g., the bid adjustment value for the {keyword, location} pair), sₖ is the amount spent for the {keyword, location} pair, and dₖ is the keyword-topical category distribution weight. For example, the amount spent for the {keyword, location} pair may correspond to the amount spent on mobile-only campaigns that use that pair. The distribution weight may be a value that represents how a keyword is attributed to multiple topical categories. For example, assume that there is a company named “Quartz Motor Company.” In such a case, the keyword “Quartz” may be associated with both an automobile-related category and a geology-related category. In some implementations, the distribution weight may represent the fraction of times the {keyword, location} pair is attributed to a particular category. In further implementations, pairs that are below a given threshold may be excluded from the calculation of the bid adjustment value for the {topical category, location} pair. For example, a keyword pair that is assigned to a particular topical category less than 100,000 times in a certain time period may be excluded.

Process 500 may include using adjustment values for {topical category, location} pairs to determine an adjustment value for a third-party content provider's campaign (block 506). Once bid adjustment values have been determined for {topical category, location} pairs, these values may be used to determine a finalized bid adjustment value for a particular third-party content provider's campaign. The finalized bid adjustment value may be calculated in any number of ways that factor in the provider's campaign parameters. In some implementations, the bid adjustment value for the provider's campaign may be calculated as a geometric average as follows:

$$log [ {m}_{c} ] = \frac{{\sum }_{v}^{N} {s}_{v} * log ( {m}_{k} )}{{{\sum }_{v}}^{N} {s}_{k}}$$

where m_{c} is the bid adjustment value for the campaign, sᵥ is the amount spent for a particular {topical category, location} pair, and mᵥ is the bid adjustment value for the {topical category, location} pair. According to some implementations, the amount spent for a {topical category, location} pair used in the calculation may correspond to the total amount spent across different device types. In other words, the bid adjustment value for a {topical category, location} pair may be calculated using weights for mobile-only amounts across the different {keyword, location} pairs, while the weight assigned to the {topical category, location} pair when calculating the adjustment value for the campaign may be weighted using its entire associated spend amount. In some cases, not every {topical category, location} pair may have a bid adjustment value. For example, some topical categories may not have enough keywords or amount spent by providers to calculate a bid adjustment value. In such cases, the {topical category, location} pair may be removed from consideration and instead added to the sum of the spend amount. In some implementations, if the covered spend for the provider is less than a threshold amount, a bid adjustment value for the provider may not be calculated and suggested. For example, a third-party content provider may not receive a suggested bid adjustment value if less than 75% of the topical categories used in his or her campaign have associated bid adjustment values. If a bid adjustment value for a third-party content provider's campaign is calculated, it may then be provided as a suggestion, such as in block 512 of process 500.

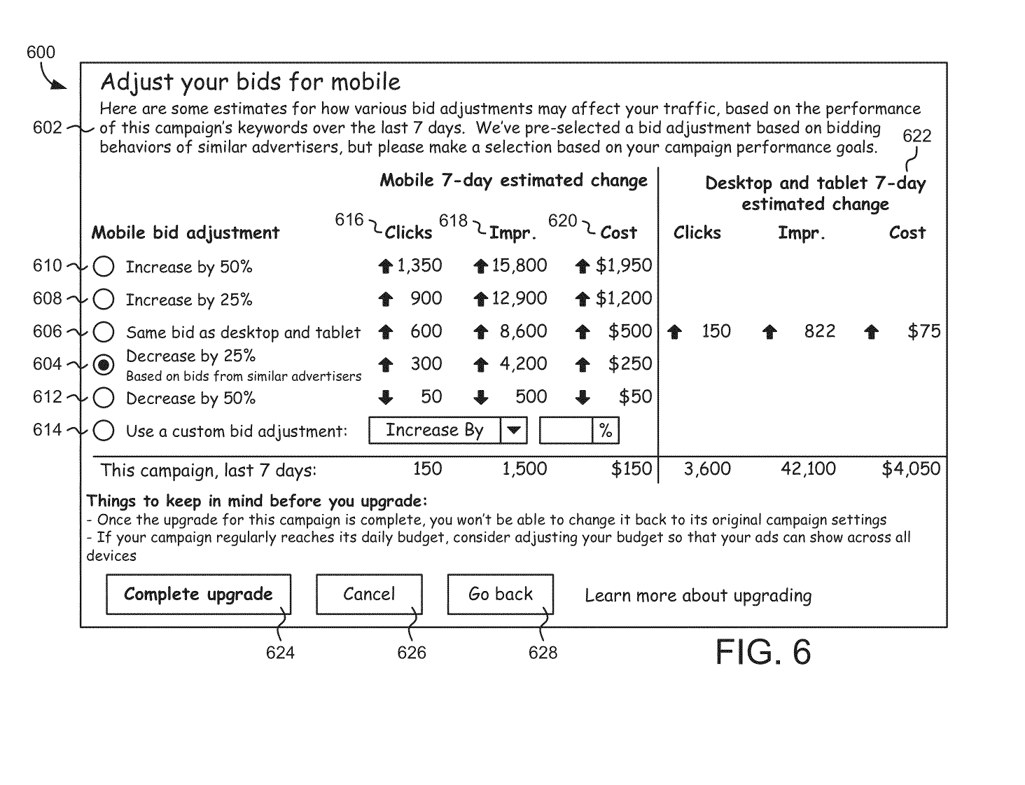

Referring now to FIG. 6, an illustration 600 is shown of a adjustment value being suggested, according to various implementations. As shown, a screen 602 may be provided to a display of a third-party content provider. Screen 602 may be used by the third-party content provider to upgrade the campaign to be a hybrid campaign (e.g., a campaign that provides content to both desktop and mobile devices) that uses a bid adjustment value to relate mobile and desktop bids.

Based on the parameters used in the third-party content provider's campaign, a suggested bid adjustment value 604 may be calculated and included on screen 602. For example, assume that the third-party content provider's campaign includes parameters that specify that the provider's content is to be included with search results for the search query keywords “flowers,” florists,” and “bouquets” on devices located in the United States of America. In such a case, the system may determine that the campaign is related to the a topical category of flower shops and calculate a corresponding bid adjustment value using bids from other providers that use similar parameters. In the example shown, assume that this calculation results in the average peer provider using a bid amount for mobile devices that is 75% of their corresponding bid amount for desktop devices. Accordingly, bid adjustment value 604 may suggest to the current third-party content provider that his or her bid amount for desktop devices should be adjusted downward by 25% to bid on mobile devices.

Screen 602 may also include any number of other bid adjustment values beyond suggested bid adjustment value 604. For example, screen 602 may include input 606 to use the same bid amount for both mobile and desktop devices, input 608 to use a bid amount for mobile devices that is 25% larger than the corresponding bid for desktop devices, input 610 to use a bid amount for mobile devices that is 50% larger than the corresponding bid for desktop devices, or input 612 to use a bid amount for mobile devices that is 50% smaller than the corresponding bid for desktop devices. In some implementations, screen 602 may also include an input 614 to receive a custom bid adjustment value specified by the third-party content provider.

In some implementations, screen 602 may include various estimates 616-622 to allow the third-party content provider to make a more informed decision when specifying a bid for mobile devices. Estimate 616 may give a breakdown of the number of expected click-throughs that may occur at mobile devices using different bid adjustment values, estimate 618 may give a breakdown of the number of expected impressions, and estimate 620 may give an expected cost. Estimates 616-622 may be total estimates or incremental estimates, in various implementations. For example, selecting the suggested bid adjustment value 604 may be estimated to cost the provider $250 more per week and result in their content being provided 4,200 more times and clicked three hundred more times. Estimates 616-622 may be determined by the content selection service, for example, by analyzing a history of bid performance for different bids. In various implementations, screen 602 may also include estimates 622 regarding the provider's bids for desktop devices. As shown, the provider's current bid amount for desktop devices is estimated to generate one hundred and fifty clicks per week, cost $75, and be provided to client devices 822 times.

Screen 602 may include any number of different inputs configured to allow the third-party content provider to accept a selected bid adjustment value, cancel the adding of a bid for mobile devices to the campaign, or return to a previous screen. For example, input 624 may apply the selected bid adjustment value from inputs 604-614 to associate a bid amount for mobile devices with the provider's campaign. Input 626, however, may cancel the transaction, thereby leaving the campaign devoted only to desktop devices. Finally, input 628 may be selected to return the provider to another screen configured to allow the campaign's parameters to be modified.

As a result of screen 602, the third-party content provider may quickly upgrade his or her desktop-only campaign to a campaign that provides content to both desktop and mobile devices. Screen 602 allows the provider to view estimated results given different bid adjustment values and make an informed decision when adding a bid for mobile devices to his or her campaign. Screen 602 also allows the provider to view a suggested bid adjustment value based on the provider's peers, thereby allowing the provider to quickly determine an appropriate bid adjustment to the provider's desktop-related bid, to specify a bid for mobile devices.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. A method for determining a bid adjustment value comprising:
accessing a first set of bid amounts used in content auctions by a plurality of content providers to provide third-party content to a first type of device;
accessing a second set of bid amounts used in content auctions by the plurality of content providers to provide third-party content to a second type of device;
determining a relationship between the first set of bid amounts and the second set of bid amounts;
identifying the plurality of content providers as using the same selection parameters as a content provider;
calculating, by one or more processors, a suggested bid adjustment value for the content provider based on the relationship between the first set of bid amounts and the second set of bid amounts used by the plurality of content providers; and
providing the suggested bid adjustment value for presentation.

2. The method of claim 1, wherein calculating the suggested bid adjustment value comprises:
calculating an average of the first set of bid amounts;
calculating an average of the second set of bid amounts; and
determining a ratio between the average of the first set of bid amounts and the average of the second set of bid amounts.

3. The method of claim 1, wherein identifying the plurality of content providers as using the same selection parameters as the content provider comprises:
identifying a set of selection parameters associated with an account of the content provider that comprises at least one of a geographic location, a topical category, or a set of search keywords, wherein the set of selection parameters are used to control whether the content provider participates in a content auction; and
determining that the set of selection parameters is associated with accounts of the plurality of content providers, wherein the set of selection parameters are used to control whether the plurality of content providers participate in the content auction.

4. The method of claim 1, further comprising:
determining an estimated click-through rate for the first device type using the bid adjustment value;
determining an estimated click-through rate for the second device type using the bid adjustment value; and
providing the estimated click-through rates for the first and second device types for display.

5. The method of claim 4, further comprising:
determining an estimated cost difference for the first device type using the estimated click-through rate for the first device type;
determining an estimated cost difference for the second device type using the estimated click-through rate for the second device type; and
providing the estimated cost differences for the first and second device types for display.

6. The method of claim 1, further comprising:
estimating a cost difference that would occur using the suggested bid adjustment value;
determining a second bid adjustment value;
estimating a cost difference that would occur using the second bid adjustment value;
providing the second bid adjustment value, the estimated cost difference for the second bid adjustment value, and the estimated cost difference for the suggested bid adjustment value for display in conjunction with the suggested bid adjustment value.

7. The method of claim 6, further comprising:
receiving a selection of the second bid adjustment value from a device associated with the content provider; and
using the second bid adjustment value to generate a content auction bid.

8. A system for determining a bid adjustment value comprising one or more processors operable to:
access a first set of bid amounts used in content auctions by a plurality of content providers to provide third-party content to a first type of device;
access a second set of bid amounts used in content auctions by the plurality of content providers to provide third-party content to a second type of device;
determine a relationship between the first set of bid amounts and the second set of bid amounts;
identify the plurality of content providers as using the same selection parameters as a content provider;
calculate a suggested bid adjustment value for the content provider based on the relationship between the first set of bid amounts and the second set of bid amounts used by the plurality of content providers; and
provide the suggested bid adjustment value for presentation.

9. The system of claim 8, wherein the one or more processors are operable to:
calculate an average of the first set of bid amounts;
calculate an average of the second set of bid amounts; and
determine a ratio between the average of the first set of bid amounts and the average of the second set of bid amounts as the relationship between the first and second sets of bid amounts.

10. The system of claim 8, wherein the one or more processors are operable to:
identify a set of selection parameters associated with an account of the content provider that comprises at least one of a geographic location, a topical category, or a set of search keywords, wherein the set of selection parameters are used to control whether the content provider participates in a content auction; and
determine that the set of selection parameters is associated with accounts of the plurality of content providers, wherein the set of selection parameters are used to control whether the plurality of content providers participate in the content auction.

11. The system of claim 8, wherein the one or more processors are operable to:
determine an estimated click-through rate for the first device type using the bid adjustment value;
determine an estimated click-through rate for the second device type using the bid adjustment value; and
provide the estimated click-through rates for the first and second device types for display.

12. The system of claim 11, wherein the one or more processors are operable to:
determine an estimated cost difference for the first device type using the estimated click-through rate for the first device type;
determine an estimated cost difference for the second device type using the estimated click-through rate for the second device type; and
provide the estimated cost differences for the first and second device types for display.

13. The system of claim 8, wherein the one or more processors are operable to:
estimate a cost difference that would occur using the suggested bid adjustment value;
determine a second bid adjustment value;
estimate a cost difference that would occur using the second bid adjustment value;
provide the second bid adjustment value, the estimated cost difference for the second bid adjustment value, and the estimated cost difference for the suggested bid adjustment value for display in conjunction with the suggested bid adjustment value.

14. The system of claim 13, wherein the one or more processors are operable to:
receive a selection of the second bid adjustment value from a device associated with the content provider; and
use the second bid adjustment value to generate a content auction bid.

15. A computer-readable storage medium having machine instructions stored therein that are executable by a processor to cause the processor to perform operations comprising:
accessing a first set of bid amounts used in content auctions by a plurality of content providers to provide third-party content to a first type of device;
accessing a second set of bid amounts used in content auctions by the plurality of content providers to provide third-party content to a second type of device;
determining a relationship between the first set of bid amounts and the second set of bid amounts;
identifying the plurality of content providers as using the same selection parameters as a content provider;
calculating a suggested bid adjustment value for the content provider based on the relationship between the first set of bid amounts and the second set of bid amounts used by the plurality of content providers; and
providing the suggested bid adjustment value for presentation.

16. The computer-readable storage medium of claim 15, wherein the operations comprise:
calculating an average of the first set of bid amounts;
calculating an average of the second set of bid amounts; and
determining a ratio between the average of the first set of bid amounts and the average of the second set of bid amounts as the relationship between the first and second sets of bid amounts.

17. The computer-readable storage medium of claim 15, wherein the operations comprise:
identifying a set of selection parameters associated with an account of the content provider that comprises at least one of a geographic location, a topical category, or a set of search keywords, wherein the set of selection parameters are used to control whether the content provider participates in a content auction; and
determining that the set of selection parameters is associated with accounts of the plurality of content providers, wherein the set of selection parameters are used to control whether the plurality of content providers participate in the content auction.

18. The computer-readable storage medium of claim 15, wherein the operations comprise:
determining an estimated click-through rate for the first device type using the bid adjustment value;
determining an estimated click-through rate for the second device type using the bid adjustment value; and
providing the estimated click-through rates for the first and second device types for display.

19. The computer-readable storage medium of claim 18, wherein the operations comprise: determining an estimated cost difference for the first device type using the estimated click-through rate for the first device type;
determining an estimated cost difference for the second device type using the estimated click-through rate for the second device type; and
providing the estimated cost differences for the first and second device types for display.

20. The computer-readable storage medium of claim 15, wherein the operations comprise:
estimating a cost difference that would occur using the suggested bid adjustment value;
determining a second bid adjustment value;
estimating a cost difference that would occur using the second bid adjustment value;
providing the second bid adjustment value, the estimated cost difference for the second bid adjustment value, and the estimated cost difference for the suggested bid adjustment value for display in conjunction with the suggested bid adjustment value;
receiving a selection of the second bid adjustment value from a device associated with the content provider; and
using the second bid adjustment value to generate a content auction bid.
